(19) United States
(12) Patent Application Publication
(10) Pub. No.: US 2020/0361798 A1
(43) Pub. Date: Nov. 19, 2020

(54) METHOD AND APPARATUS TO INCREASE WASTEWATER BIOREACTOR PROCESSING CAPACITY WHILE REDUCING GREENHOUSE GAS EMISSIONS

(71) Applicant: Marcus G. Theodore, Salt Lake City, UT (US)

(72) Inventor: Marcus G. Theodore, Salt Lake City, UT (US)

(73) Assignee: Earth Renaissance Technologies, LLC, Salt Lake City, UT (US)

(21) Appl. No.: 16/412,302

(22) Filed: May 14, 2019

(51) Int. Cl. C02F 1/52; C02F 1/00; C02F 3/00

(52) U.S. Cl. CPC C02F 1/5236; C02F 2101/20; C02F 3/00; C02F 1/004

(57) ABSTRACT

A wastewater treatment method and apparatus separating suspended solids in influent wastewater streams, and injecting SO₂ or sulfurous acid into the suspended solids at a pH and dwell time to generate sufficient sulfurous acid with free SO₂, sulfites and bisulfites to self-agglomerate the suspended solids, acid leach heavy metals contained in and on the suspended solids into solution for subsequent separation, condition the suspended solids for chemical dewatering producing a dried biofuel biosolid with less than 10% by weight water and a BTU content between 6,000 and 9,000 BTU/lb., and gasifying or combusting the dried acid treated suspended solids to produce power or energy with reduced greenhouse gas emissions.

### BACKGROUND OF THE INVENTION

### Field

This invention relates to wastewater treatment methods to reduce greenhouse gas emissions. More particularly, it relates to a treatment method and apparatus, which is directed to expanding wastewater treatment plant capacity, improving wastewater treatment plant water quality, increasing net energy production, and reducing greenhouse gas emissions.

### State of the Art

Most large municipal systems employ a series of settling ponds sequentially concentrating the solids contained in wastewater either with or without polymers for separation from liquids via mechanical separation means, such as belt presses. To produce a clean effluent that can be safely discharged to watercourses, wastewater treatment operations use distinct stages of treatment to remove harmful contaminants. Preliminary wastewater treatment usually involves gravity sedimentation of screened wastewater to remove settled solids. Secondary wastewater treatment is accomplished through a biological process, removing biodegradable material. This treatment process uses microorganisms to consume dissolved and suspended organic matter, producing carbon dioxide and other by-products. The removal capacity of these secondary bioreactors is dependent upon the influent suspended solids and dissolved solids and nutrient concentration loads placed on them. Tertiary or advanced treatment is used when extremely high-quality effluent is required with reduced solid residuals collected through tertiary treatment consisting mainly of chemicals added to clean the final effluent, which are reclaimed before discharge, and therefore not incorporated into bio-solids.

Wastewater treatment plants employ different types of bioreactors using microbes and bacteria to reduce biosolids, BOD, nitrogen and phosphorous compounds contained in wastewater influent. These produce 2% of all the non-biogenic greenhouse gas emissions in the U.S., see “What are the worst greenhouse gases and why?”, Oct. 31, 2018, http://science.answers.com/Q/What_are_the_worst_greenhouse_gas...

Globally, wastewater treatment plants generate 3% of all the non-biogenic greenhouse gas emissions; see Sewage Plants Overlooked Source of CO2 by Bobby Magill, Climate Central dated Oct. 8, 2018, wwvv.climatecentral.org/news/sewageplants-overlooked-co2. The source of these greenhouse gas emissions from a wastewater treatment plant are:

Sludge reuse 37%

Anaerobic Digestion 35%

Biomass Decay 6%

BOD removal 5%

Nitrogen Removal 5%

Nitrous Oxide Removal 1%, and

Energy Consumption from coal and natural gas 11%.

Non-biogenic greenhouse gas emissions are defined as those emissions from natural fermentative biological processes, which are not counted, so only the Energy Consumption Segment greenhouse gases of 11% are counted from coal, wood, and natural gas consumption. Thus the largest emissions from sludge reuse of 37% for land application and 35% for anaerobic digestion are ignored as biogenic. If included, the actual carbon dioxide emissions from wastewater treatment operations are 9 times the 2% non-biogenic emissions.

Of the greenhouse gas emissions produced by microbes and bacterial, carbon dioxide is the most prevalent emitted greenhouse gas and can be somewhat reduced. Methane is produced in a lesser amount, but is 31 times more effective in trapping heat in the atmosphere than CO₂ and can be reduced. Another greenhouse gas emitted by wastewater treatment plant microbes and bacteria is nitrous oxide. Nitrous oxide is 310 time more effective in trapping heat than CO₂ and can be reduced.

Anaerobic digestion is used to reduce the sludge disposal volume generated by a wastewater treatment plant 40 to 50%. It generates low BTU biogas releasing methane and CO2, gases when not recaptured. 1200 wastewater treatment plants in the US still use anaerobic digestion, and only half of these capture the released biogas.

Anaerobic digestion is a slow biological process requiring a large footprint, is energy and capital intensive, and difficult to control environmental conditions for digestion. It also still requires landfilling the balance of the sludge not reduced.

Land application sludge reuse is used for aerobic decomposition of the sludge producing carbon dioxide gas, hydrogen sulfide gas, SOx, NOx, and water. Although it is not as susceptible to environmental conditions as anaerobic digestion, it requires solids drying to reduce disposal volume. It also has a long decomposition time measured in years tying up land used for disposal. It also generates undesirable odors, and produces more sludge than anaerobic processes, requiring a larger landfill footprint; see “Introduction in the technical design for anaerobic treatment systems” by Dipi-Ing. Heinz-Peter Mang.

Both anaerobic digestion and land application of sludge release into the environment sorbed heavy metals, pathogens, pharmaceuticals, personal care products, and hazardous prions on the sludge substrate. Sludge substrate decomposition also releases significant amounts of methane into the air.

To ensure that biosolids applied to the land do not threaten public health, the U.S. Environmental Protection Agency (EPA) requires compliance with 40 CFR Part 503 Rules categorizing biosolids as Class A or B, depending on the levels of pathogenic organisms in the material, and describes specific processes to reduce pathogens to these levels.

The 503 rule also requires heavy metals reduction and “vector attraction reduction” (VAR)—reducing the potential for spreading of infectious disease agents by vectors (i.e., flies, rodents and birds)—and spells out specific management practices, monitoring frequencies, record keeping and reporting requirements. Incineration of biosolids is also covered in the regulation.

These conventional Class A Biosolids treatment methods are generally energy intensive to achieve rapid disinfection, or take a long time for biodegradation. The chemical treatment method described below provides a low energy treatment method rapidly dewatering sludge for energy production, heavy metals, PPCP, hazardous prion and pathogen removal to improve water quality while expanding wastewater treatment plant capacity and reducing greenhouse gas emissions.

### SUMMARY OF THE INVENTION

The present method and apparatus is a wastewater treatment method for wastewater streams and/or conventional wastewater treatment plant process liquid streams containing suspended solids. It comprises removing all or a portion of the suspended solids in wastewater influent streams and/or conventional wastewater treatment plant process liquid streams entering a bioreactor. The resultant filtrate has reduced solids, N, P, and BOD to minimize the load on the bioreactor, but with sufficient dissolved and suspended solids suitable to support bacteria and microbe bioreduction of remaining nitrogen, phosphorous, BOD, and other nutrients.

SO₂ or sulfurous acid is then injected into the separated suspended solids at a pH and dwell time to generate sufficient sulfurous acid with free SO₂, sulfites and bisulfites to:

i. self-agglomerate the colloidal suspended solids,

ii. acid leach heavy metals contained in and on the suspended solids into solution for subsequent removal and separation, and

iii. condition the suspended solids for subsequent chemical dewatering shedding water upon separation and drying without polymers. By avoiding hydrophilic polymers for coagulation, a much drier biosolid results using sulfurous acid coagulation.

Heat drying is required as wet biosolids must be dried to less than 20% water before power generation. For example, polymer coagulated sludge typically has 40% water, requiring large drying energy—typically 60% of the fuel value produced; see “Techno-Economic Analysis of Wastewater Biosolids Gasification” by Nick Lumley et al; ww3 aiche.or...p325428.p...

The SO₂ treated solids are then placed on drying beds or dewatering equipment to chemically dry to less than 10% water in 24 to 48 hours. This produces a greater than 90% renewable biosolid fuel having approximately 6,000 to 9,000 BTU/lb. without drying heat energy as an energy sink. This dried biosolid has approximately the same fuel value as woodchips and can be readily gasified or combusted as a co-fired fuel.

The chemically dried solids are then gasified or combusted to generate power; avoiding landfill costs and reducing aerobic and anaerobic greenhouse gas emissions.

These chemically dried solids provide 25% more fuel value than anaerobically digested sludge as anaerobic microbes consume half of the higher energy volatiles as they produce biogas methane and carbon dioxide. For example primary dried solids have a BTU value of approximately 9,000 BTU/lb. vs waste activated sludge having a BTU value of approximately 6,500 BTU/b.; see “Renewable Energy Resources: Banking on Bisolids”, by the National Association of Clean Water Agencies (NACWA) Cal.Res.Bur., August 2007, Moller, Rosa Marie, “A brief on Biosolids Options for Biosolids Management”, P. 37.

Gasifiers produce different emissions depending, upon the temperature. According to Wikipedia.

“The dehydration or drying process occurs at around 100° C. Typically the resulting steam is mixed into the gas flow and may be involved with subsequent chemical reactions, notably the water-gas reaction if the temperature is sufficiently high.

The pyrolysis (or devolatilization) process occurs at around 200-300° C. Volatiles are released and char is produced, resulting in up to 70% weight loss for coal. The process is dependent on the properties of the carbonaceous material and determines the structure and composition of the char, which will then undergo gasification reactions.

The combustion process occurs as the volatile products and some of the char react with oxygen to primarily form carbon dioxide and small amounts of carbon monoxide, which provides heat for the subsequent gasification reactions. Letting C represent a carbon-containing organic compound, the basic reaction here is C+O2→CO₂

The gasification process occurs as the char reacts with steam and carbon dioxide to produce carbon monoxide and hydrogen, via the reactions C+H₂O→H₂+CO and C+CO2→2 CO.

In addition, the reversible gas phase water-gas shift reaction reaches equilibrium very fast at the temperatures in a gasifier. This balances the concentrations of carbon monoxide, steam, carbon dioxide and hydrogen. CO+H₂O↔CO₂+H₂.”

Thus, lower temperature gasifiers produce CO and unburnt carbon for subsequent combustion. Higher temperature plasma gasifiers produce syngas CO and H₂ with the lowest emissions when combusted

Combusting biogas methane thus produces half the power of plasma gasification Syngas combined cycle plants.

Biogas Combustion

CH₄+2O₂CO₂+2H₂O

Syngas Combustion

CO+H₂+(Cₛₒₗ)+O₂→CO₂+H₂O

Combustion or gasifying chemically dried filtered biosolids not only provides better net energy production, but avoids anaerobic processes producing higher CO₂ equivalent methane, and N₂O greenhouse gases as typical biogas contains 50-75% methane and 25-50% CO₂. It also contains N₂ 0-10%, and H₂S 0-3%. Combustion of biogas therefore releases significantly more greenhouse gases when compared to combustion and gasification of separated dried solids.

For example:

C₆H₁₂O₆+6O₂→6 CO₂+6H₂O Aerobic-CO₂, H₂O produced

C₆H₁₂O₆→3 CO₂+CH₄ (31×CO_{2eq}) Anaerobic biogas-Methane+CO₂

CO+H₂+(Cₛₒₗ)+O₂→CO₂+H₂O Syngas Combustion-CO2, H2O

This upfront separation/filtration of the influent total suspended biosolids reduces bioremediation loading 40%, expanding wastewater treatment plant capacity. It also lowers the filtered wastewater nitrogen and phosphorous content approximately 25%. This reduces wastewater treatment time and energy consumption to remove the remaining wastewater nitrogen and phosphorus, and minimizes anoxic/noxic methane, nitrous oxide greenhouse gas production.

In addition, improved reclaimed water quality results by upfront suspended solids removal, as these total suspended solids act as a carbon adsorbent attaching contaminants such as heavy metals, pharmaceuticals and personal care products hazardous prions, and pathogens to their substrate.

The water quality is further improved by salt balancing to protect plant roots, which osmotically absorb nutrients and are harmed by saline wastewaters. Salt balancing uses sulfurous acid and lime bi-valent ions to repel and leach away from the roots monovalent salts, such as sodium chloride, and retains other needed nitrogen and phosphorous plant nutrients. This allows for raising a wide variety of high value salt sensitive crops without costly membrane filtration. These reclaimed wastewaters are also suitable for further bioremediation where stream discharge requires higher nitrogen and phosphorous removals.

The liquid fraction is then pH adjusted above or approximately 6.5 before transfer to a bioreactor for bioremediation to remove remaining nitrogen, phosphorous, and nutrients to the degree required to meet wastewater treatment plant discharge requirements for land application or open stream discharge. Where heavy metals are significant, the pH is first raised above pH 9 with lime to precipitate heavy metal hydroxides, calcium phosphate, and metal sulfates for filtration removal before pH adjustment for bioremediation or land application.

The present method employing upfront removal and chemical drying of total suspended solids in a wastewater stream for combustion and/or gasification destroys sorbed PPCPs/pathogens/prions. It reduces wastewater treatment plant bioremediation loading, expanding plant capacity, and avoids greenhouse gases from anaerobic biosolids reduction. It also generates increased net power, and leaves an improved treated reclaimed water metal free, land appliable for all crops, and is suitable for further bioremediation for open stream discharge.

### DESCRIPTION OF THE DRAWINGS

FIG. 1 illustrates the source of greenhouse gas emissions for a typical wastewater treatment plant.

FIG. 2 illustrates the percentages of greenhouse gas emissions from various wastewater treatment plant processes.

FIG. 3 illustrates how suspended solids substrates adsorb PPCPs, pathogens, heavy metals, which are released when the substrate is broken down by microbes.

FIG. 4 illustrates salt balancing with bi-valent ions to repeal and leach away from the roots monovalent salts, retaining needed plant nutrients.

FIG. 5 illustrates the fuel value of anaerobically digested sludge vs. separated primary solids.

FIG. 6 illustrates acid cation agglomeration of colloidal biosolids without polymers.

FIG. 7 illustrates separated biosolids drying energy usage for polymer separated sludges vs. chemically dried separated solids.

FIG. 8 illustrates an example of a flow diagram removing upfront suspended solids for chemical drying, and conditioning the filtrate as reclaimed water for land application or further processing.

The patent or application file contains at least one drawing executed in color. Copies of this patent or patent application publication with color drawing(s) will be provided by the Office upon request and payment of the necessary fee.

### DESCRIPTION OF THE ILLUSTRATED EMBODIMENTS

An example of the present invention will be best understood by reference to the drawings. The components, as generally described and illustrated, could be arranged and designed in a wide variety of different configurations. Thus, the description of the embodiments is not intended to limit the scope of the invention, as claimed, but is merely representative of presently preferred embodiments of the invention.

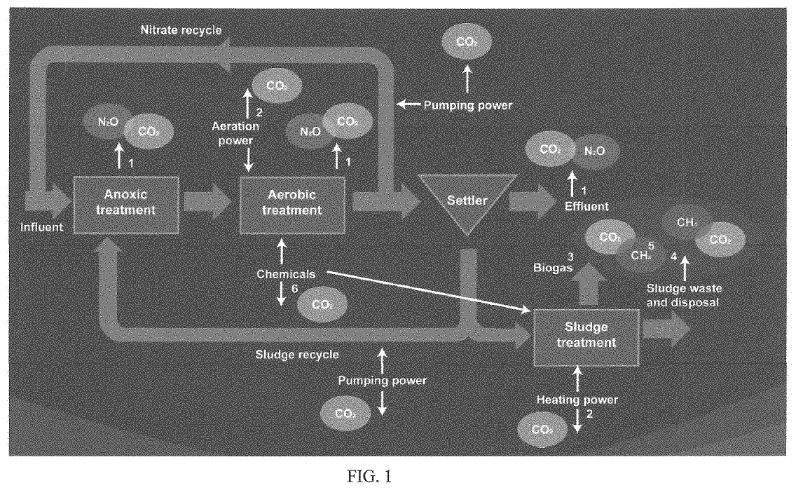

FIG. 1 illustrates the source of greenhouse gas emissions for a typical wastewater treatment plant.

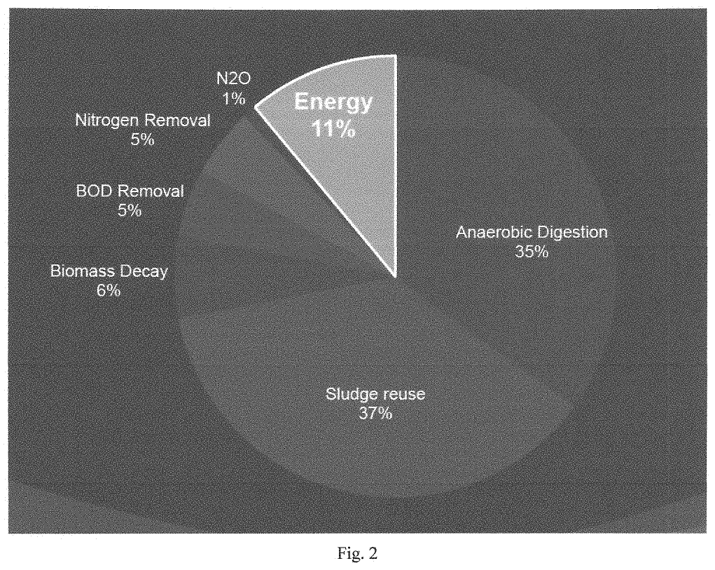

FIG. 2 illustrates the percentages of greenhouse gas emissions from various wastewater treatment plant processes illustrated in FIG. 1. Land application produces 37% of the greenhouse gas emissions followed by anaerobic digestion producing 35% of the greenhouse gas emissions. Gasification/combustion of the upfront separated suspended solids avoids both these processes to significantly reduce greenhouse gas production while generating power.

For example, anaerobic digestion is used to reduce sludge disposal volume to at best 50%. The process generates low BTU biogas releasing methane and CO₂ greenhouse gases, if not captured. Presently 600 wastewater treatment plants in the US flare off this biogas directly to atmosphere, losing any fuel benefit and compounding greenhouse gas emissions. More importantly, this process still requires landfilling of the balance of the sludge resulting in a large footprint as biological processes are slow to degrade these remaining sludges.

Land application decomposition produces CO₂, H₂S, SOx, NOx, and H₂O greenhouse gas emissions. It also requires solids drying to reduce the disposal volume and has a long decomposition time in years, continually emitting greenhouse gases to atmosphere, while generating odors.

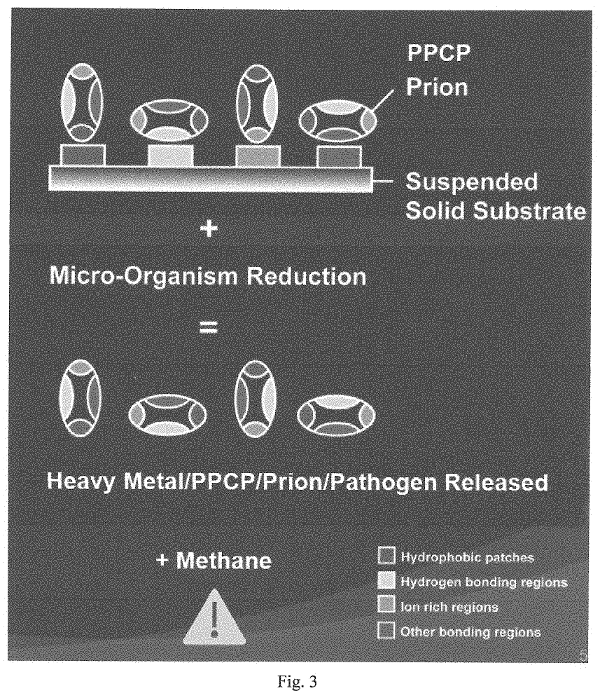

FIG. 3 illustrates how suspended solids substrates adsorb PPCPs, pathogens, heavy metals, which are released when the substrate is broken down by microbes. Their upfront removal significantly improves reclaimed water quality and reduces loading on a wastewater treatment plant's bioremediation equipment; thereby expanding its processing capacity. Gasification/Combustion of the separated solids then destroys the sorbed PPCPs, prions, pathogens. Heavy metals are separately acid washed from the solids substrate for chemical precipitation via lime addition to precipitate metal hydroxides for independent disposal.

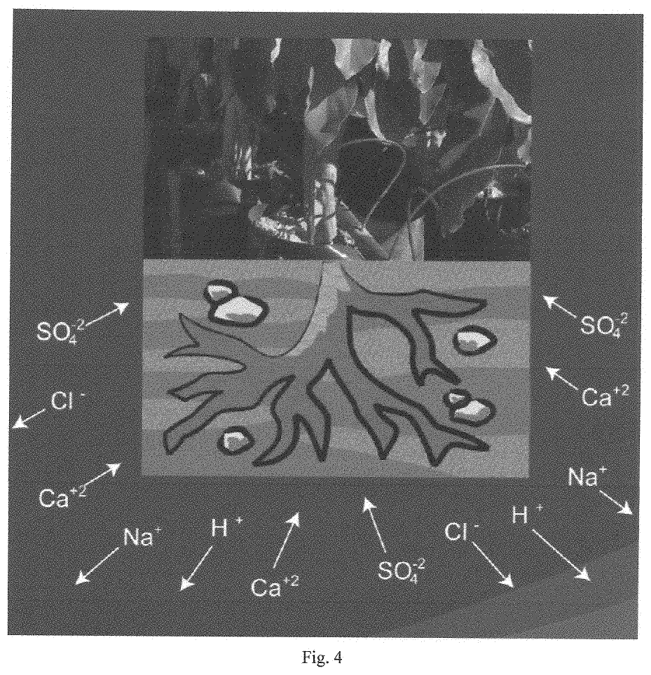

FIG. 4 illustrates salt balancing with bi-valent ions to repeal and leach away from the roots monovalent salts, retaining needed plant nutrients.

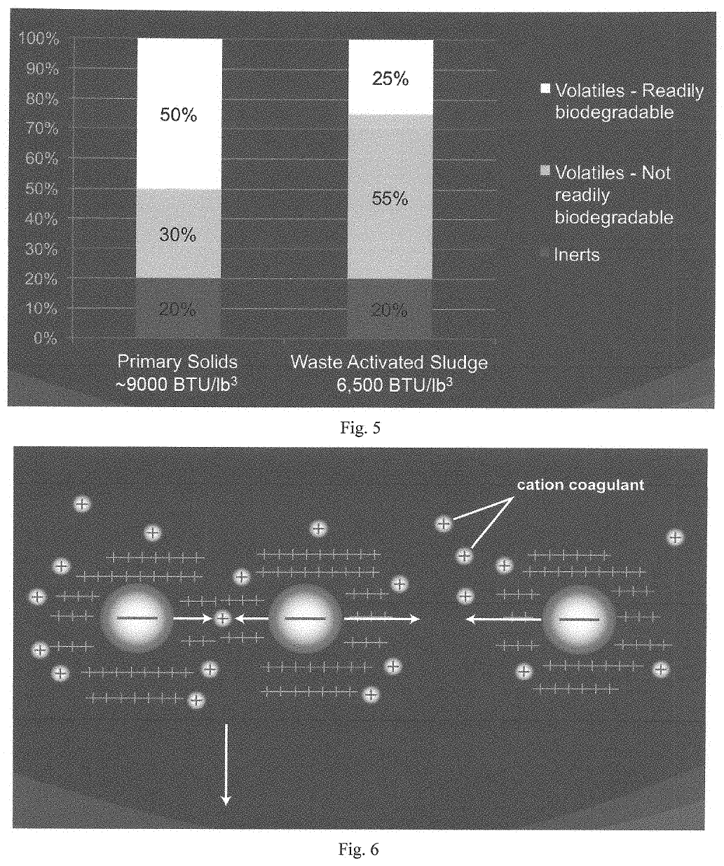

FIG. 5 illustrates the fuel value of anaerobically digested sludge vs. separated primary solids. Separated primary solids have 25% more fuel value than anaerobically digested sludge as the anaerobic microorganisms first consume the high energy volatiles to produce biogas. Thus the fuel value of primary separated solids is approximately 9,000 BTU/lb. compared to waste activated separated sludge having a BTU value of approximately 6,500 BTU/lb.

FIG. 6 illustrates acid cation agglomeration of colloidal biosolids without polymers. Suspended solids are negatively charged, and when cation acid is added, they readily coagulate for easy separation. As the acid addition avoids hydrophilic polymers, the sulfurous acid chemically dried biosolids contain less than 10% water vs. 40% water of polymer separated solids.

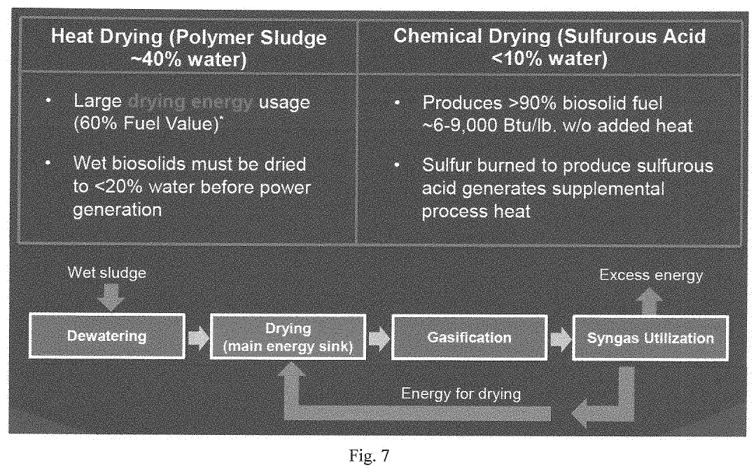

FIG. 7 illustrates separated biosolids drying energy usage for polymer separated sludges vs. chemically dried separated solids. For gasification or combustion, the separated biosolids must be dried to less than 20% water content before power generation. This requires large drying energy usage of polymer separated solids, which constitutes approximately 60% of the fuel value according to “Techno-Economic Analysis of Wastewater Biosolids Gasification” by Nick Lumley et al; ww3.aiche.org/...?p325428.p..., supra. Chemically dried separated solids thus generates significantly more fuel value than dried polymer separated fuels.

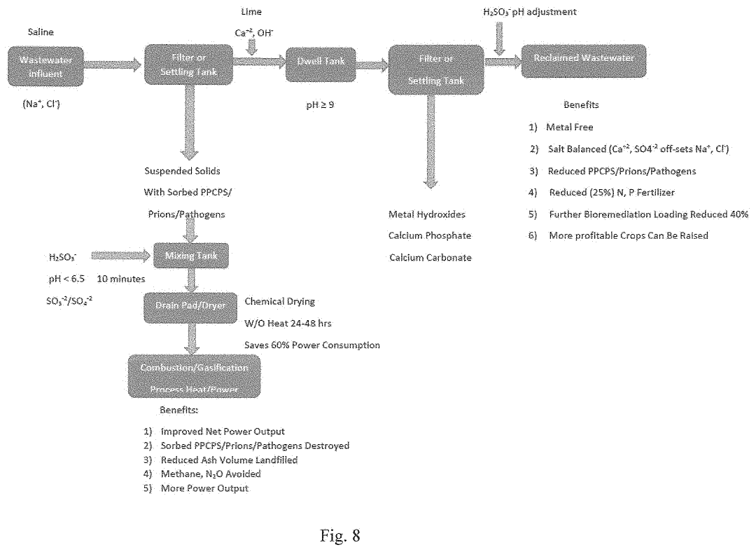

FIG. 8 illustrates an example of a flow diagram removing upfront suspended solids for chemical drying, and conditioning the filtrate as reclaimed water for land application or further bioremediation processing. The saline wastewater is filtered using centrifuges, clarifiers, or mechanical filters removing the suspended solids with sorbed PPCPs/Prions/Pathogens for transfer to a mixing tank. Sulfurous acid at a pH less than 6.5 is then added and held for approximately 10 minutes The slurried acidified separated solids is then transferred to a drain Pad/Dryer, belt press, etc. for chemical drying without heat. After 24 to 48 hours, the chemically dried solids have less than 10% water and are transferred to a gasifier or combuster, such as a kiln, co-fired boiler, etc. This destroys sorbed PPCPs/Prions/Pathogens, while generating more power output with reduced greenhouse gases, as methane and nitrous oxide anaerobic production are avoided.

The filtrate is then lime adjusted in a dwell tank at a pH greater than or equal to 9 for precipitating metal hydroxides, calcium phosphates, and calcium carbonates for separation with a filter or settling tank. The second filtrate is then pH adjusted with sulfurous acid, producing a reclaimed wastewater which is metal free, salt balanced, and has reduced PPCPs/Prions/Pathogens and reduced N and P. It may be land applied or further bioremediated with loading reduced 40%.

Upfront TSS removal before biological reduction significantly increases the capacity of the wastewater treatment plant to reduce BOD, nitrogen, and greenhouse gas production. It also provides a renewable biofuel for co-firing with other fuels to reduce overall greenhouse gas production, particularly when co-fired with coal significantly reducing NOx and SOx production.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

I claim:

1. A wastewater treatment method for wastewater streams and/or wastewater treatment plant process liquid streams containing suspended negatively charged colloidal solids in solution comprising:
a. removing all or a portion of the solids from solution,
b. adding SO₂ or sulfurous acid with free SO₂, sulfites and bisulfites to the removed solids at a pH and dwell time to:
i. self-agglomerate the solids,
ii. acid leach heavy metals contained in and on the solids into the solution for subsequent removal and separation, and
iii. condition the suspended solids to dewater;
c. separating the SO₂ or sulfurous acid treated solids allowing them to dry to create a biosolid with less than 10% by weight water and a BTU content between 6,000 and 9,000 BTU/lb., and
d. gasifying or combusting the dried acid treated suspended solids to produce power or energy with greenhouse gas emissions less than emitted by landfilling and/or anaerobic digestion.

2. The wastewater treatment method according to claim 1, including transferring the solution with reduced solids and BOD to a bioreactor for bioremediation to remove remaining nitrogen, phosphorous, and nutrients to the degree required to meet wastewater treatment plant discharge requirements.

3. The wastewater treatment method according to claim 1, wherein the heavy metals in solution are removed via alkalization precipitation and filtration removal.

4. The wastewater treatment method according to claim 3, wherein hydrated or anhydrous lime is used to precipitate heavy metals for removal.

5. A wastewater treatment apparatus for wastewater streams and/or wastewater treatment plant process liquid streams containing suspended negatively charged colloidal solids in solution comprising:
a. means for removing all or a portion of the solids from solution,
b. means for adding SO₂ or sulfurous acid with free SO₂, sulfites and bisulfites to the removed solids at a pH and dwell time to:
i. self-agglomerate the solids,
ii. acid leach heavy metals contained in and on the solids into the solution for subsequent removal and separation, and
iii. condition the suspended solids to dewater;
c. means for separating the sulfurous acid treated solids allowing them to dry to create a biosolid with less than 10% by weight water and a BTU content between 6,000 and 9,000 BTU/lb., and
d. means for gasifying or combusting the dried acid treated suspended solids to produce power or energy with reduced greenhouse gas emissions less than emitted by landfilling and/or anaerobic digestion.

6. The wastewater treatment apparatus according to claim 5, wherein the means for gasifying comprises a gasifier or plasma gasifier, and the means for combustion comprises a co-fired boiler or kiln.

7. The wastewater treatment apparatus according to claim 5, including alkalization means of the heavy metals in solution, and filtration means for removal of heavy metals precipitate and phosphates.

8. The wastewater treatment apparatus according to claim 7, wherein the alkalization means comprises liming equipment to precipitate heavy metals for removal.

5. wastewater treatment apparatus according to claim 5, wherein the means for adding sulfurous acid comprises a sulfurous acid generator combusting raw sulfur producing SO₂ for injection into the wastewater and/or separated solids.
